(19) United States
(12) Patent Application Publication
(10) Pub. No.: US 2014/0215375 A1
(43) Pub. Date: Jul. 31, 2014

(54) PRESENTING SHORTCUTS TO PROVIDE COMPUTER SOFTWARE COMMANDS

(71) Applicant: APPLE INC., Cupertino, CA (US)

(72) Inventors: Linda L. Dong, San Francisco, CA (US); Michael P. Stern, San Francisco, CA (US)

(73) Assignee: Apple Inc., Cupertino, CA (US)

(21) Appl. No.: 13/754,318

(22) Filed: Jan. 30, 2013

(51) Int. Cl. G06F 3/0489

(52) U.S. Cl. CPC G06F 3/0489
USPC 715/773

(57) ABSTRACT

Presenting shortcuts to provide computer software commands. A user interface associated with a computer software application, which includes multiple portions, is displayed. Each portion is associated with a command to perform an operation of the application in response to the command. In response to a selection of a particular portion of the user interface, another user interface is displayed. In the other user interface, a name of a particular command and a keyboard shortcut key selectable to perform an operation in response to the particular command are displayed. Additionally, a virtual keyboard that includes multiple alphanumeric keys, including the keyboard shortcut key, is displayed in the other user interface. The keyboard shortcut key is displayed on the virtual keyboard to be visually distinct from remaining alphanumeric keys on the virtual keyboard.

### TECHNICAL FIELD

This disclosure relates generally to providing commands to perform computer software operations.

### BACKGROUND

Computer software applications can be implemented by computer systems as instructions (for example, code) stored on computer-readable media and executable by one or more data processing apparatuses. A computer software application can be implemented to receive input (or a command), for example, from a user, to perform an operation. The computer system can process the input resulting in an output and can present the output, for example, display the output on a display device connected to the computer system. Some computer software applications can be implemented to provide one or more graphical user interfaces through which commands can be received and in which output can be displayed. A command can be provided to a computer software application using one or more input devices including, for example, a mouse, a touch screen, a stylus, a keyboard, and the like, or combinations of the input devices.

In some situations, the computer software application can be configured to receive different commands from different input devices to perform the same operation. For example, a digital multimedia content item (such as a video, an image, text, a file, and the like) can be displayed in a user interface. A command to copy the digital multimedia content item can include a selection of a control object displayed in the user interface (for example, a “Copy” control object displayed in a “Menu” portion of the user interface) using a position indicator (such as a cursor) controlled by a mouse. Alternatively, the command to copy the item can include a selection of one or more keys on a keyboard (for example, a selection of “Ctrl” followed by “C”). Thus, keys on the keyboard can serve as alternatives or shortcuts to provide at least some commands to the computer software application. A user, however, may not be able to easily identify such shortcut keys.

### SUMMARY

This disclosure describes technologies relating to presenting shortcuts to provide computer software commands.

In general, one innovative aspect of the subject matter described here can be implemented as a computer-implemented method. A first user interface associated with a computer software application is displayed. The first user interface includes multiple portions associated with multiple commands for performing computer software operations of the computer software application. A selection of one of the multiple portions that is associated with a subset of the multiple commands is detected. A second user interface that is separate from the first user interface is displayed in response to detecting the selection. In the second user interface, a name of a command within the subset of commands and a keyboard shortcut key selectable to perform a computer software operation in response to the command, are displayed. In the second user interface, a virtual keyboard that includes multiple alphanumeric keys including the keyboard shortcut key is displayed. The keyboard shortcut key on the virtual keyboard is displayed to be visually distinct from remaining alphanumeric keys of the multiple alphanumeric keys included in the virtual keyboard.

This, and other aspects, can include one or more of the following features. Detecting the selection can include detecting a placement of a position indicator adjacent the one of the multiple portions, and detecting a selection of the one of the plurality of portions using the position indicator. A name of the one of the plurality of portions can be displayed in response to detecting the placement of the position indicator adjacent the one of the plurality of portions. A visual indicator can be displayed in the one of the plurality of portions in response to detecting the placement of the position indicator adjacent the one of the plurality of portions. In the second user interface, names of the multiple portions including a name of the one of the plurality of portions can be displayed. A focus can be placed on the name of the one of the plurality of portions in the second user interface. The one of the plurality of portions can include a control object selectable to perform the command. Input to place the computer software application in a mode can be detected. The second user interface can be displayed in response to detecting the selection when the computer software application is in the mode. The keyboard shortcut key can be modified in response to detecting input to modify the keyboard shortcut key in the second user interface. In response to detecting the input to modify the keyboard shortcut key, it can be determined that a modified keyboard shortcut key has been assigned to perform another command of the computer software application. A message can be displayed in the second user interface notifying that the modified keyboard shortcut key has been assigned to perform the other command. Multiple names of multiple commands can be stored in a computer-readable storage medium. The multiple names can include the name of the command. The multiple names can be displayed in a list. Displaying, in the second user interface, the name of the command can include identifying the name from the multiple names, and displaying the identified name as a first name in the list.

Another innovative aspect of the subject matter described here can be implemented as a computer-readable medium storing instructions executable by data processing apparatus to perform operations that include identifying a first user interface associated with a computer software application. The first user interface includes multiple portions. Each portion is associated with respective multiple commands to perform respective multiple computer software operations of the computer software application. The operations include displaying a second user interface that is separate from the first user interface, and displaying, in the second user interface, names of the multiple portions. The operations include detecting a selection of a name of one of the multiple portions that is associated with a subset of the multiple commands and displaying names of the subset of the multiple commands in the second user interface in response to detecting the selection of the name of the one of the multiple portions. A keyboard shortcut key has been assigned to a command of the subset of the multiple commands. The operations include displaying, in the second user interface, a virtual keyboard that includes multiple alphanumeric keys including the keyboard shortcut key and displaying the keyboard shortcut key on the virtual keyboard to be visually distinct from remaining alphanumeric keys of the multiple alphanumeric keys included in the virtual keyboard.

This, and other aspects, can include one or more of the following features. The operations can include displaying, in the second user interface, a selectable control, and names of all commands to perform all operations of the computer software application in response to detecting a selection of the selectable control. Keyboard shortcut keys have been assigned to a subset of all commands. The operations can further include displaying, in the second user interface, another selectable control and names of the subset of all commands to which keyboard shortcut keys have been assigned. The operations further include displaying, in the second user interface, keyboard shortcut keys assigned to the subset of all commands. The operations further include displaying a visual indicator over each alphanumeric key that has been assigned as a keyboard shortcut key to a command. The operations can further include detecting a selection of an alphanumeric key of the multiple alphanumeric keys, identifying one or more alphanumeric keys, which, in combination with the alphanumeric key, have been assigned as respective one or more respective keyboard shortcut keys to respective one or more commands, and displaying a respective one or more visual indicators over each of the respective one or more alphanumeric keys. The operations can further include detecting a selection of a name of the names of the subset of the multiple commands, determining that the name is associated with a command to which a keyboard shortcut key has been assigned, and displaying a visual indicator over the keyboard shortcut key assigned to the command. The operations can further include detecting a selection of a name of the names of the subset of the multiple commands, determining that the name is associated with a command to which a keyboard shortcut key has been assigned, and displaying, in the second user interface, the keyboard shortcut key assigned to the command. The operations can further include modifying the keyboard shortcut key in response to detecting input to modify the keyboard shortcut key in the second user interface.

A further innovative aspect of the subject matter described here can be implemented as one or more data processing apparatus, and a computer-readable medium storing instructions executable by the one or more data processing apparatus to perform operations described here.

The details of one or more embodiments of the subject matter described in this specification are set forth in the accompanying drawings and the description below. Other features, aspects, and advantages of presenting shortcuts to provide commands will become apparent from the description, the drawings, and the claims.

### BRIEF DESCRIPTION OF THE DRAWINGS

FIG. 1 is an example of a computer system for presenting shortcuts to perform computer software commands.

FIGS. 2A-2G are examples of user interfaces that display keyboard shortcut keys selectable to provide commands to perform computer software operations.

FIGS. 3A and 3B are examples of user interfaces displayed when placing a computer software application in a mode to display keyboard shortcut keys.

FIGS. 4A and 4B are examples of user interfaces that display keyboard shortcut keys to provide commands to the computer software application.

FIGS. 5A and 5B are examples of user interfaces that display keyboard shortcut keys to provide commands to the computer software application.

FIG. 6 is a flowchart of a process for displaying names of commands and keyboard shortcut keys assigned to some of the commands in user interfaces.

FIG. 7 is a flowchart of a process for displaying names of multiple commands associated with portions of a user interface.

FIG. 8 is a flowchart of a process for displaying names of multiple commands associated with portions of a user interface.

FIG. 9 is a block diagram of an exemplary architecture for implementing the features and operations of FIGS. 1-8.

Like reference numbers and designations in the various drawings indicate like elements.

### DETAILED DESCRIPTION

This disclosure generally describes computer-implemented methods, computer software, and computer systems for presenting shortcuts to provide computer software commands. A computer software application (for example, a graphical user interface-based application) can be implemented to provide a user interface that includes multiple portions. Each portion can be associated with commands that can be provided to the application to perform computer software operations. For example, the user interface can include a viewing portion associated with commands to view a digital multimedia content item (such as a video). The commands associated with the viewing portion can include a “Play” command, a “Stop” command, a “Pause” command, a “Rewind” command, and a “Forward” command, to name a few. The user interface can additionally include an editing portion associated with commands to edit the digital multimedia content item. The commands can include a “Select” command, a “Crop” command, a “Copy” command, a “Delete” command, to name a few. Additional examples of portions of a user interface and commands associated with respective portions are described below. Some or all commands associated with a portion can be logically related to each other by a logical relationship. In the example above, commands associated with the viewing portion can be related to viewing the digital multimedia content item. Similarly, commands associated with the editing portion can be associated with editing the item.

Commands to cause the application to perform the operations can be provided using input devices such as a position indicator (for example, a mouse, a stylus), a touch screen configured to receive a touch input, a microphone configured to receive an audio input, a keyboard, and the like. Using the keyboard to provide a command to perform an operation can be an alternative to using other input devices to provide a command to perform the same operation. Moreover, a user may need to perform fewer steps to provide a command using a keyboard relative to steps to provide a command using other input devices. For example, to copy an object displayed in a user interface using the mouse, the user may need to access a drop-down menu of commands, scroll the menu to identify the “Copy” command control object, and select the “Copy” command control object. Instead, to perform the same copy operation, the user can select the combination of “Ctrl+C” on a keyboard. In this manner, keys on the keyboard can be assigned as shortcuts (or alternatives) to provide a command to perform an operation using other input devices.

This disclosure describes grouping and categorizing commands that can be provided to cause a computer software application (“application”) to perform operations into groups based on the logical relationships between one or more portions of the user interfaces provided by the application and the commands associated with the portions. This disclosure also describes presenting (for example, displaying) the grouped commands in user interfaces such that users can quickly and easily identify commands. In this manner, the grouped commands can serve as user interface tools that users can use to find and select commands. Additionally, the user interfaces that present the grouped commands can display commands to which shortcut keys have been assigned and keys on the keyboard that have been assigned as shortcut keys to commands. Moreover, using the user interfaces, a shortcut key (or keys) can be assigned to a command or shortcut keys that have previously been assigned to a command can be modified (for example, changed, deleted, and the like) or both.

Grouping and categorizing commands according to logical relationships described above can simplify an organization and presentation of commands. Names of commands associated with each portion of the user interface can be presented to the user according to the logical relationships. Such a presentation of commands can enable a user to easily and quickly identify all commands associated with a portion of a user interface provided by the application. For example, the presentation can leverage a user's pre-existing familiarity with the user interface to enable the user to quickly select commands and to ascribe shortcuts to selected commands. Moreover, to view all commands associated with a portion, the user need only select a name of the portion. In addition, keyboard shortcut keys assigned to some or all of the commands can be presented together with the names of the commands. Such a presentation of keyboard shortcut keys according to the logical relationships can allow the user to view all keyboard shortcut keys associated with commands in a portion of the user interface. The grouping and categorizing of commands can simplify and sometimes reduce the tasks that the user needs to perform to view available commands and associated keyboard shortcut keys. The design of the user interface in which the keyboard shortcut keys are presented can also be simplified creating an efficient workflow.

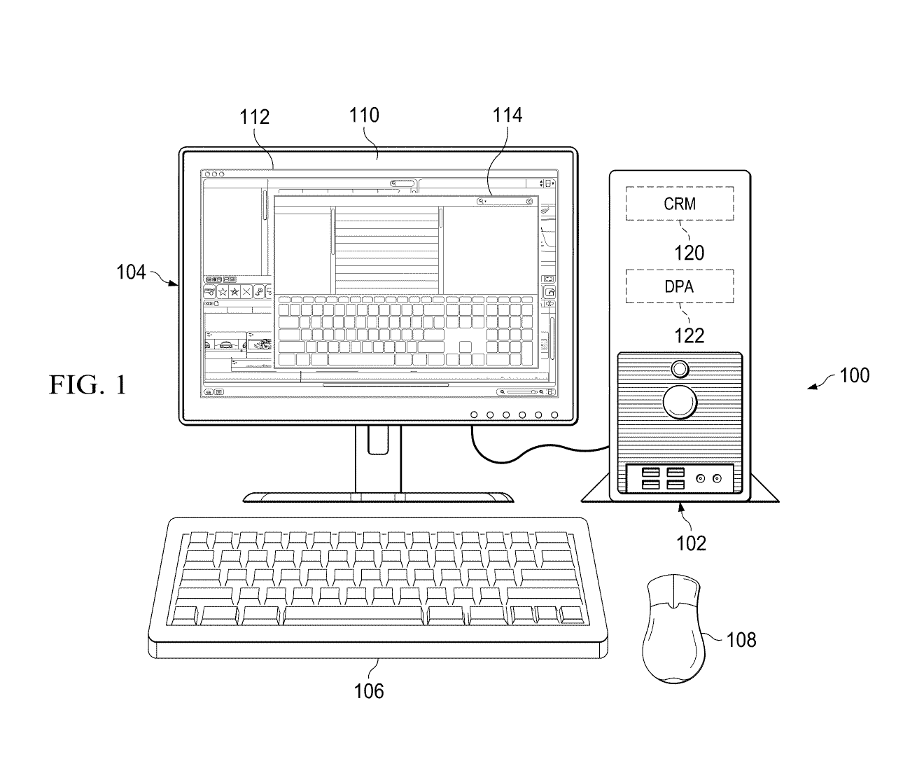

FIG. 1 is an example of a computer system 100 for presenting shortcuts to perform computer software commands. The computer system 100 can implement a computer software application, for example, as computer instructions stored on a computer-readable medium (CRM) 120 and executable by data processing apparatus (DPA) 122 that are components of a computer 102. The computer system 100 can include one or more input devices (for example, a keyboard 106, a mouse 108, and the like) and one or more output devices (for example, a display device 104) that are connected to the computer 102. The computer system 100 can be a desktop computer, a laptop computer, a tablet computer, a smartphone, a personal digital assistant (PDA), and the like.

The computer system 100 can execute the application to present user interfaces (for example, user interface 110) in the display device 104. In some implementations, the computer system 100 can display a first user interface 112 associated with the application. The first user interface 112 can include multiple portions. Each portion can be associated with a command to perform a computer software operation of the application in response to the command. The computer system 100 can leverage the logical relationship between a portion of the first user interface 112 and commands that are associated with the portion to group and categorize commands and keyboard shortcut keys assigned to the commands. To do so, the computer system 100 can store (for example, in the CRM 120) a hierarchy in which the first user interface 112 represents a root node and each portion of the first user interface represents a respective leaf node of the root node. In the hierarchy, commands associated with each portion represent leaf nodes of each portion. Some or all of the commands in each portion are associated with shortcut keys that can be used as alternatives to provide the commands to the application.

The computer system 100 can present (for example, display) commands grouped according to the logical relationships in a second user interface 114. In some implementations, the computer system 100 can detect a selection of a portion of the first user interface 112 that is associated with a command. The computer system 100 can display the second user interface 114 that is separate from the first user interface 112 in response to detecting the selection. In the second user interface 114, the computer system 100 can display names of the multiple portions of the first user interface 112, and also display names of commands associated with the portions. The computer system 100 can display the name of each command as a selectable object. In response to a selection of such an object, the computer system 100 can place a focus on the selected object and display additional information about the command. The computer system 100 can implement the second user interface 114 to receive assignments or modifications (or both) to shortcut keys that can be selected to provide the command. The computer system 100 can additionally display, in the second user interface 114, a virtual keyboard that can be used to visually communicate keys that have been used as shortcut keys for several commands in general, and a command in specific.

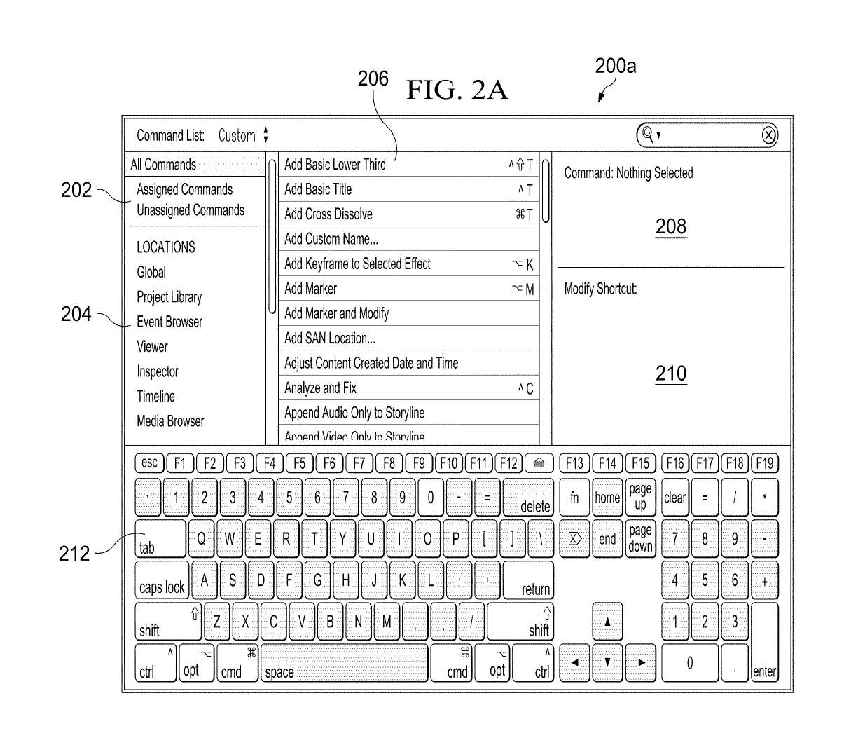

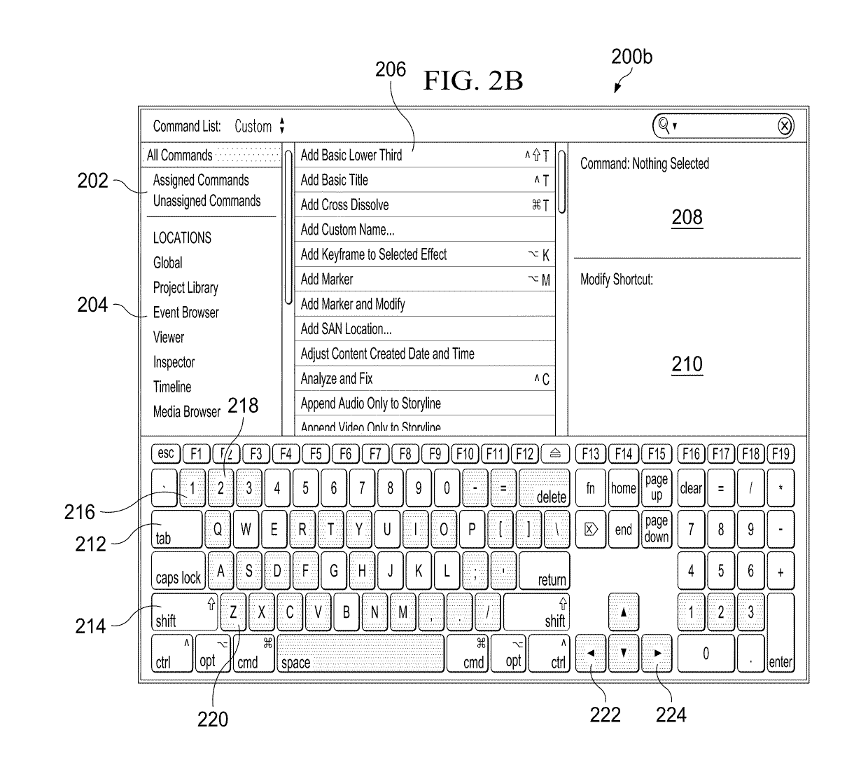

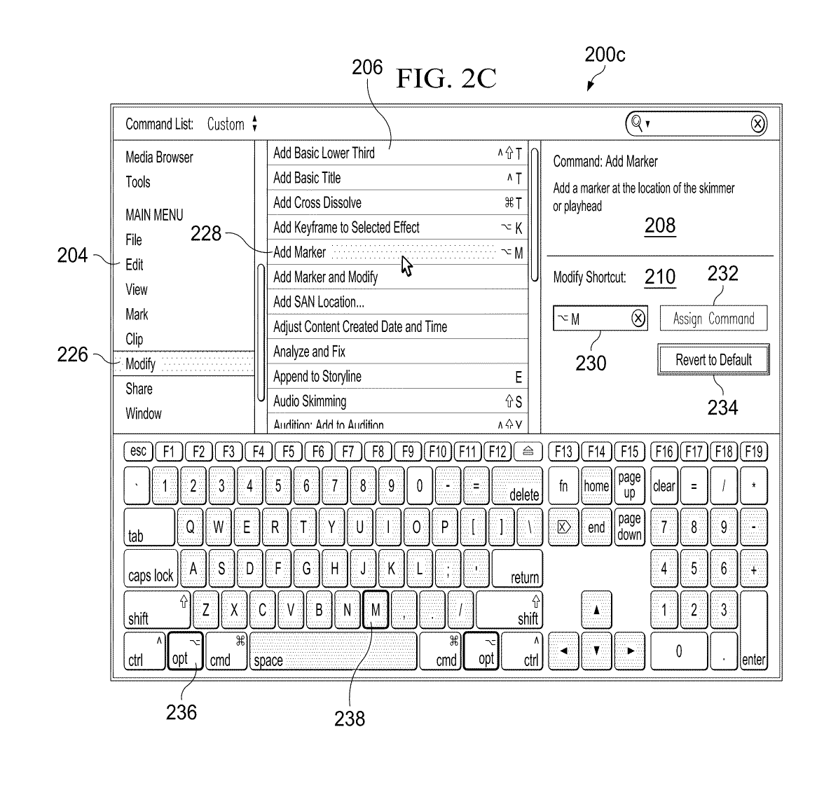

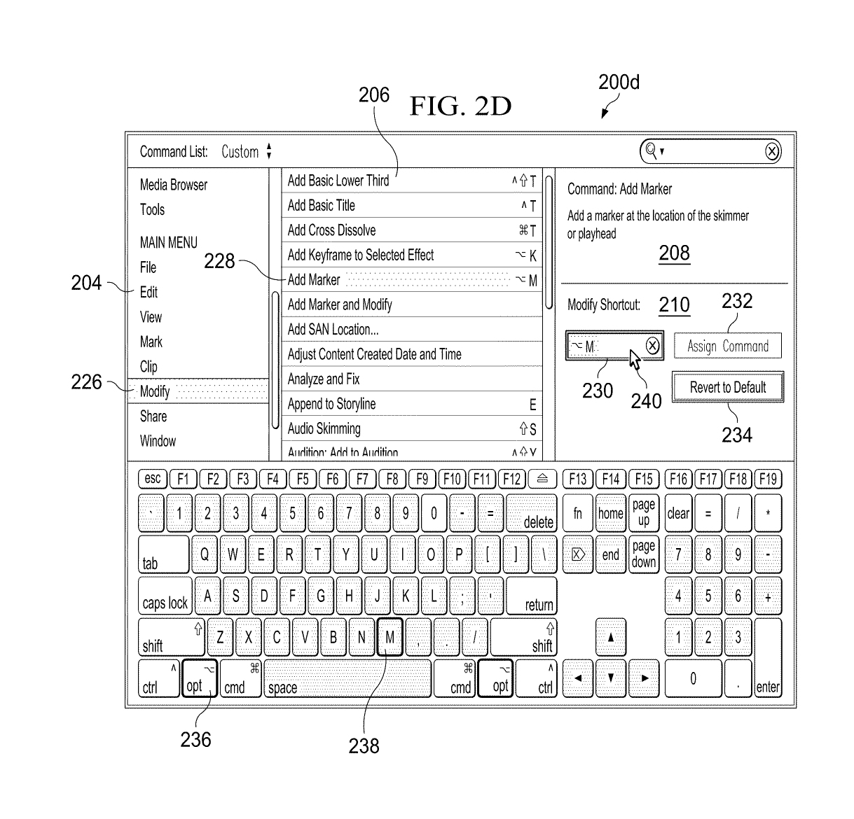

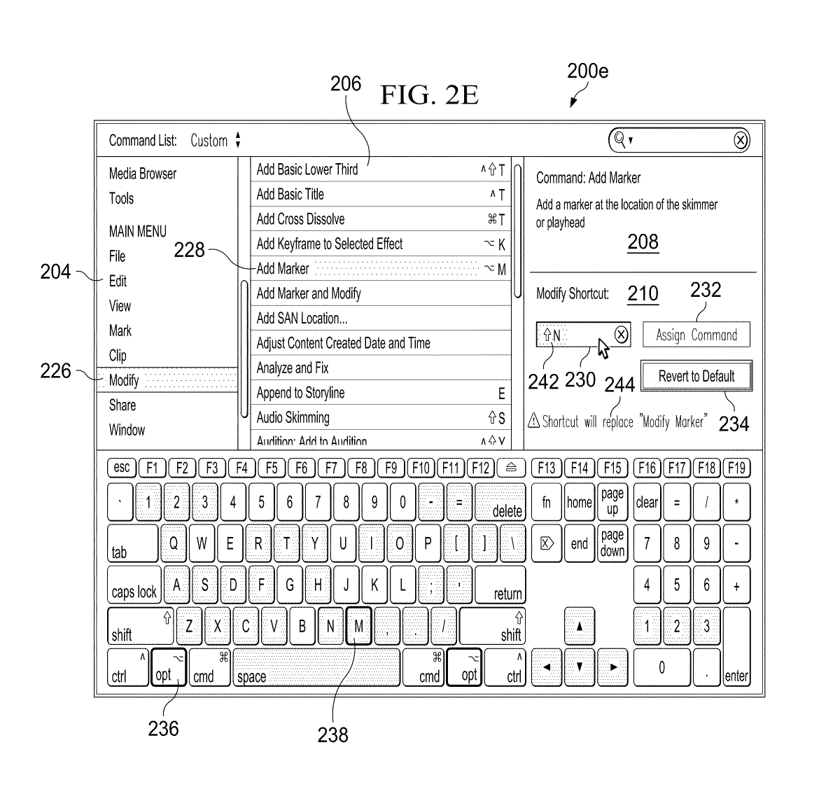

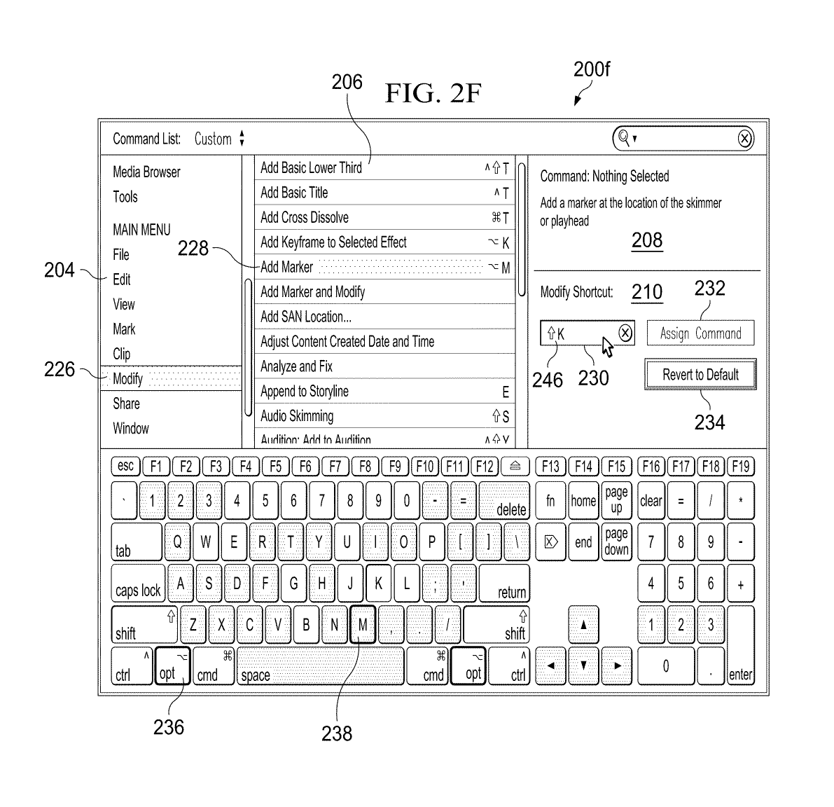

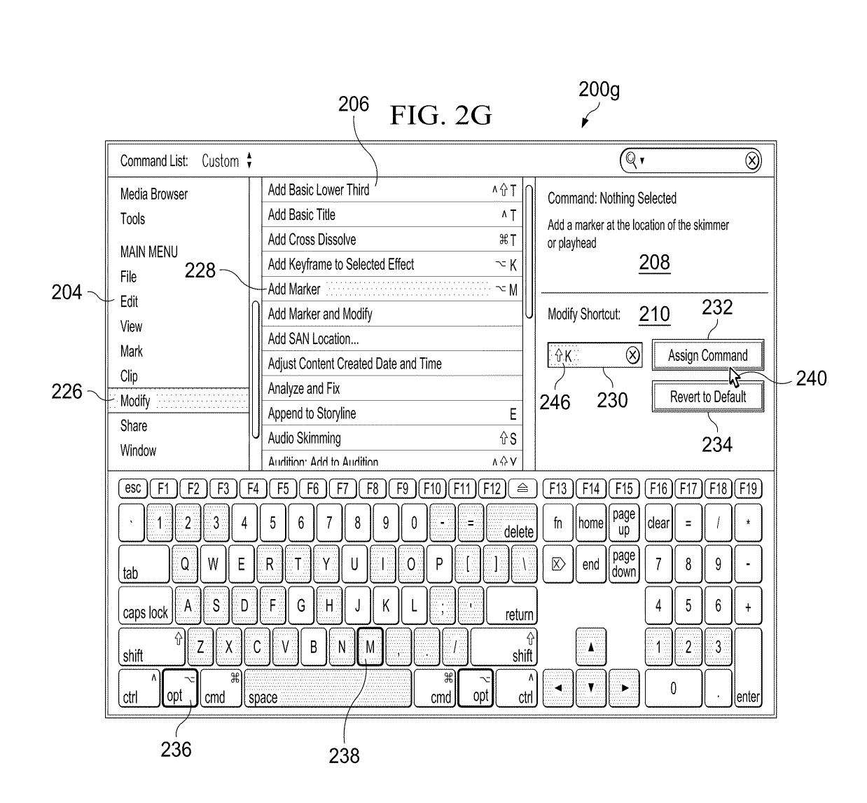

FIGS. 2A-2G are examples of user interfaces that can display information describing multiple commands that a graphical user interface-based computer software application can receive to perform operations. The information can describe portions of user interfaces provided by the application and are associated with commands. The information can also include names of the commands and keyboard shortcut keys assigned to some or all of the commands. The user interfaces illustrated in FIGS. 2A-2G are described with reference to a graphical user interface-based application to edit digital multimedia content items such as video, audio, images, text, and the like. In general, the user interfaces can be included in any application in which shortcut keys can be assigned to commands. For example, the user interfaces can serve as help tools to enable users of an application to easily and quickly identify commands associated with the application and shortcut keys associated with some or all of commands.

A computer system, for example, the computer system 100, can be implemented to provide each of the user interfaces shown in FIGS. 2A-2G, for example, by executing, using a data processing apparatus (such as, DPA 122), computer instructions stored on a computer-readable medium (such as, CRM 120). In some implementations, the computer system 100 can execute the graphical user interface-based application. The computer system 100 can store names of all commands associated with the application on a computer-readable storage device, for example, the CRM 120 or a storage device that is external to the CRM 120 or external to the computer 102.

Additionally, the computer system 100 can store descriptions of operations that can be performed by the application in response to receiving commands. For example, the computer system 100 can implement the application to display an object representing a digital multimedia content item in a user interface. The computer system 100 can additionally display a “Select” control object, which, when selected, can place the application in a selection mode. In the selection mode, the computer system 100 can receive a selection of the digital multimedia content item (for example, for copying, deleting, and the like). Thus, the operation that the computer system 100 can perform in response to receiving a command to select the “Select” control object is to make the “Select” control object active. The description of the operation, therefore, can be “Make the ‘Select’ control object active.” The computer system 100 can store similar descriptions of all operations that the computer system 100 can perform when executing the application.

Additionally, the computer system 100 can store hierarchical information describing logical relationships relating multiple portions of the application and commands associated with each of multiple portions on the computer-readable storage device. In some implementations, the computer system 100 can store a name of each of the multiple portions and associate names of commands associated with each portion with the name of each portion. The computer system 100 can also store a shortcut key assigned to each of one or more of the commands associated with the application. As described above, the application can be encoded to include shortcut keys. Most or all shortcut keys can be mapped by a user to provide respective commands encoded in the application. Such shortcut keys can be stored on the computer-readable storage device, for example, when the application is installed on the computer system 100. The computer system 100 can receive input through the user interfaces shown in FIGS. 2A-2G to view some or all of the commands associated with the application. As described below, some of the input can represent filtering criteria based on which the computer system 100 can filter the commands to display the names of a subset of all commands associated with the application.

FIG. 2A, for example, illustrates a user interface 200a that lists commands associated with a graphical user interface-based application that includes multiple portions. In some implementations, the computer system 100 can display the user interface 200a in the display device 104, while executing an application. For example, the computer system 100 can display the user interface 200a in response to receiving an input from a user requesting that the interface be displayed.

In the user interface 200a, the computer system 100 can display a first portion 202 on which a user of the computer system 100 can view some or all of the commands associated with the application. For example, in the first portion 202, the computer system 100 can display three selectable controls—“All Commands,” “Assigned Commands,” and “Unassigned Commands.” When the user selects the “All Commands” control, the computer system 100 can display names of all commands associated with the application in a second portion 206 (known, in some implementations, as “an outline view” or “a list view”), for example, as a scrollable list of commands. If the user selects the “Assigned Commands” control, the computer system 100 can display names of commands that are associated with the application and to which shortcut keys have been assigned. If the user selects the “Unassigned Commands” control, the computer system 100 can display names of commands that are associated with the application and to which shortcut keys have not been assigned.

In the user interface 200a, the computer system 100 can display a keyboard portion 212 that includes a virtual keyboard (i.e., an image of all alphanumeric keys on a keyboard using which commands can be provided to the application). Not all keys on the keyboard may have been used as shortcut keys. In some implementations, the computer system 100 can display the keys that have been used as shortcut keys differently (for example, in a different color) from the keys that have not. The computer system 100 can identify the keys that have been used as shortcut keys by accessing a computer-readable storage device, for example, the CRM 120, on which information identifying such keys was stored when the application was installed on the computer system 100. As described below, the computer system 100 can display each key in the keyboard portion 212 or only those keys that have been used as shortcut keys as selectable objects.

Additionally, the computer system can display a third portion 204 that includes names of the multiple portions of the user interface provided by the application. As described above, each portion is associated with multiple commands that share a logical relationship with the portion. When a name of a portion displayed in the third portion 204 is selected, the computer system 100 can identify all commands associated with the portion and display the identified commands in the outline view (i.e., the second portion 206). Upon detecting a selection of a command in the second portion, the computer system 100 can display a description of an operation (or operations) that can be performed by the application in response to receiving the command in the fourth portion 208. The computer system 100 can additionally display shortcut keys assigned to the selected command in the fifth portion 210. Also, the computer system 100 can enable a user to assign shortcut keys to the command in the fifth portion 210.

A single key on the keyboard can be a shortcut to trigger a command or be one of multiple keys, which in combination, can be shortcut keys to provide the command. FIG. 2B illustrates a user interface 200b that can display one or more keys, which, in combination with a key, have been assigned as shortcuts to provide commands. As described above, the computer system 100 can display each key in the keyboard as a selectable object. The computer system 100 can receive a selection of a key 214 (for example, the “Shift” key) in the keyboard portion 212. For example, a user can select the key 214 by positioning a position indicator (such as a cursor) controlled by a mouse over the key 214 and selecting the key. Alternatively, the user can touch the key 214 in a touch screen to select the key. In another example, the user can speak the name of the key into a microphone to select the key.

In response, the computer system 100 can access the computer-readable storage device to determine if the key 214 alone has been assigned as a shortcut to provide a command. The key 214 (for example, the “Shift” key) may have also been included in a combination of multiple keys. The selection of the combination of multiple keys can be a shortcut to trigger another command. For example, the combination of the “Shift” key and the key 216 (i.e., the “1” key), the combination of the “Shift” key and the key 218 (i.e., the “2” key), the combination of the “Shift” key and the key 220 (i.e., the “Z” key), the combination of the “Shift” key and the left arrow key, or the combination of the “Shift Key” and the right arrow key can each be a shortcut to trigger a respective command. The computer system 100 can identify the one or more combinations of multiple keys, each of which includes the key 214. The computer system 100 can display the key 214 in a first format (for example, in a first color) to indicate a selection of the key 214, and display the multiple keys (for example, keys 216, 218, 220, 222, 224) in a second format (for example, in a second color) different from other keys on the keyboard. The first format and second format can visually communicate the key 214 and the multiple keys that have been assigned as shortcut keys to provide commands to a user viewing the user interface 200b. The computer system 100 can detect a selection of one of the multiple keys (for example, key 216) when the key 214 has been selected. In response, the computer system 100 can display a name of a command or, if the command is already displayed, highlight the command to which the combination of the key 214 and the key 216 has been assigned as the shortcut key in the second portion 206.

FIG. 2C illustrates a user interface 200c that displays information describing a selected command and a shortcut key assigned to the selected command. In some implementations, the computer system 100 can display categories of commands in the third portion 204. Each category in the categories can be displayed in a respective physical area of the user interface associated with the application, for example, the first user interface 112. Alternatively, or in addition, each category in the categories can represent other groupings like assigned or unassigned commands. Selecting one of the categories can cause the computer system 100 to filter the complete list of application commands to a smaller set that pertains to the selected category. For example, the categories can include a “File” category, an “Edit” category, a “Modify” category, and the like, each of which is displayed in the title bar when the application is executed. Each category can be associated with multiple commands. That is, when a category displayed in the title bar is selected, a drop-down menu is displayed showing multiple commands.

In the user interface 200e, the computer system 100 can detect a selection of a category 226 (for example, the “Modify” category). In response, the computer system 100 can display names of the multiple commands associated with the category 226 in the second portion 206 of the user interface 200c. With each name, the computer system 100 can display a shortcut assigned to provide the command, if available. The computer system 100 can display each name as a selectable control object and a key or keys of the shortcut keys in the selectable control object. The computer system 100 can detect a selection of a control object 228 (for example, the control object that displays “Add Marker”). In response, the computer system 100 can identify information describing the command associated with the control object 228 by accessing the computer-readable storage device and display the information in the fourth portion 208. In this example, the information describing the “Add Marker” command can be “Add a marker at the location of the skimmer” or “Add a marker at the location of the playhead” which the computer system 100 can display in the fourth portion 208.

In the fifth portion 210, the computer system 100 can display the shortcut keys to provide the command associated with the control object 228, if available. In this example, the shortcut keys “Opt+M” have been assigned to the “Add Marker” command. The computer system 100 can display “Opt M” in a selectable control object 230 in the fifth portion 210. In addition, the computer system 100 can display the shortcut keys (i.e., the “Opt” key 236 and the “M” key 238, in this example) in the keyboard portion 212 in a manner such that the shortcut keys can be visually discerned. For example, the computer system 100 can display a border around the “Opt” key and the “M” key.

A user can modify the shortcut keys as illustrated in user interface 200d described with reference to FIG. 2D. To do so, a user can position a position indicator 240 (such as a cursor) over the selectable control object 230 and select the object. The user can alternatively select the object 230 using a touch screen or other input device. To modify the existing shortcut keys, the user can select a new shortcut key (or keys), for example, by selecting the selectable keys in the keyboard portion 212. The user can alternatively use a keyboard to select the new shortcut key (or keys). In the example shown in user interface 200e (FIG. 2E), the user has selected “Shift+N” to replace “Opt+M” as the shortcut keys for “Add Marker.” The computer system 100 can display the new shortcut keys 242 in the selectable control object 230 in the fifth portion 210. The user can then select the “Assign Command” control object 232 to assign the new shortcut keys 242 to the “Add Marker” command.

In some implementations, the computer system 100 can compare the new shortcut keys 242 with existing shortcut keys to determine if the new shortcut keys 242 have already been assigned to another command. In this example, the computer system 100 can determine that “Shift+N” has previously been assigned to the “Modify Marker” command. In response to this determination, the computer system 100 can display a notification 244 in the fifth portion 210, such as a message that states “Shortcut will replace ‘Modify Marker’.” Upon viewing the notification, the user can either change the new shortcut keys 242 or assign the new shortcut keys 242 to the command associated with the selectable control object 228, for example, by selecting the “Assign Command” control object 232.

As shown in user interface 200f (FIG. 2F), the user can select different shortcut keys 246 instead of the new shortcut keys 242 shown in user interface 200e. In this example, the user can select “Shift+K” instead of “Shift+N.” The computer system 100 can determine that the different shortcut keys 246 have not been previously assigned to any command, and consequently may not display any notification. In some implementations, the computer system 100 can display a notification that the different shortcut keys 246 are available to be assigned to the command. As shown in user interface 200g (FIG. 2G), the user can then select the “Assign Command” control object 232 to assign the different shortcut keys 246 (“Shift+K” in this example) to the command associated with the selectable control object 228 (“Add Marker”) in this example. The computer system 100 can additionally display a “Revert to Default” control object 234, a selection of which can cause the shortcut assigned to the command associated with the selectable control object 228 to revert to the default shortcut key (“Opt+N” in this example).

The user interfaces described above with reference to FIGS. 2A-2G can serve as help tools to enable users of the digital multimedia editing application to easily and quickly identify commands associated with the application and shortcut keys associated with some or all of commands. In some implementations, the computer system 100 can detect input to place the application in a mode (known, in some examples, as a “Command Navigator” mode) to present information describing portions of the user interfaces provided by the digital multimedia editing application. In response to the input to place the application in the mode, the computer system 100 can present the information and present keyboard shortcut keys to provide commands to the application in user interfaces such as those described above with reference to FIGS. 2A-2G.

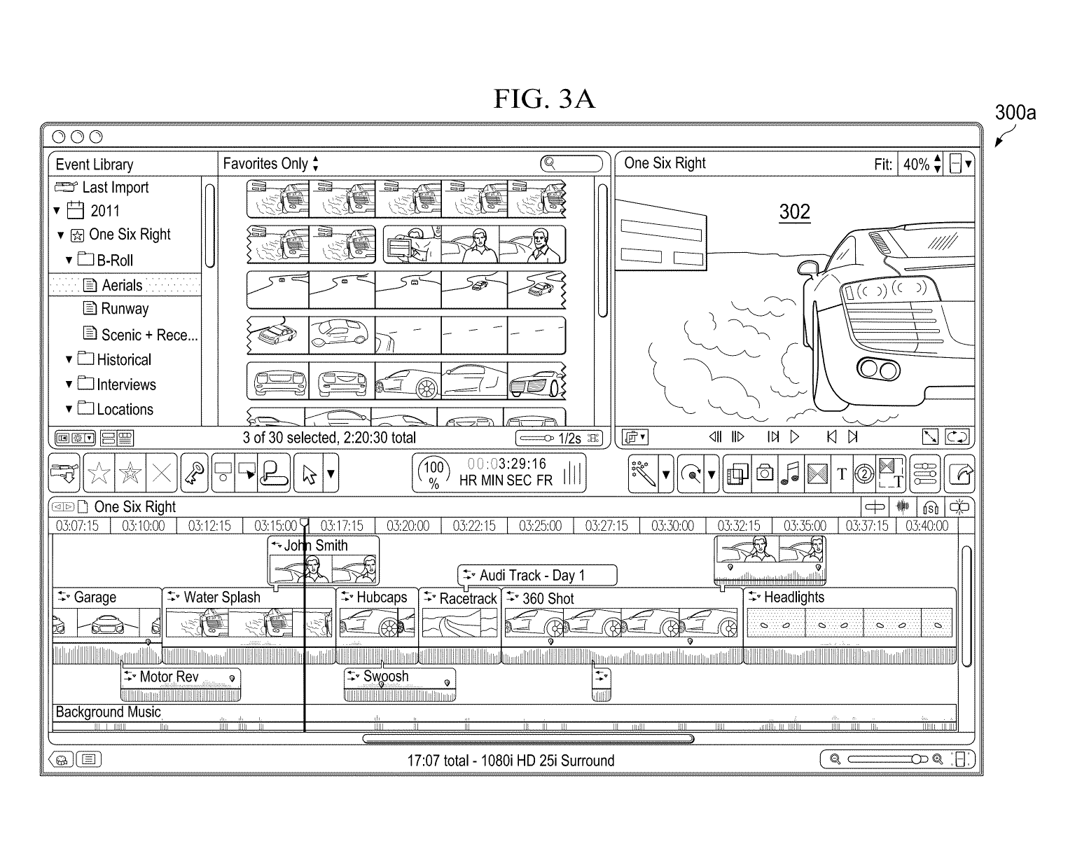

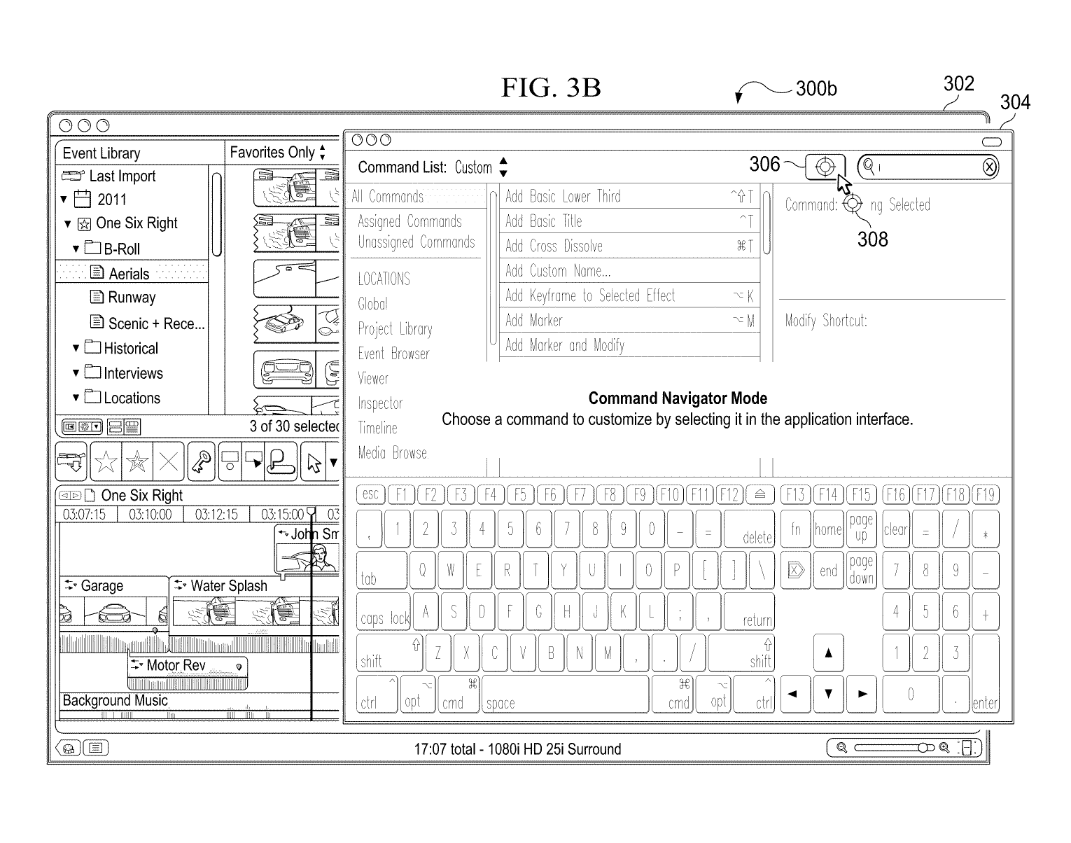

FIG. 3A illustrates a user interface 300a that the computer system 100 displays upon executing the application. For example, the application is a digital multimedia editing application configured to display and edit digital multimedia content items such as video, images, audio, and the like. The computer system 100 can execute the application to display the user interface 300a, for example, in a display device. The user interface 300a can include multiple portions, each of which is associated with multiple commands to perform computer software operations. In response to receiving the multiple commands, the computer system 100 can perform respective operations. For example, the user interface 300a can include a viewing portion 302, which, in turn, can include multiple control objects through which the computer system 100 can receive input to view a digital multimedia content item.

In some implementations, the user interface 300b (FIG. 3B) can include a control object that a user can select using one or more input devices to place the application in the mode. In response to receiving the input, the computer system 100 can display a second user interface 304 that is separate from the first user interface 300b. In some implementations, the computer system 100 can display a control object 306 in the second user interface 304, a selection of which can remove the application from the mode. For example, a user can select the control object 306 using a position indicator 308 controlled by a mouse or a stylus. In such examples, the computer system 100 can display the position indicator to have a first appearance when the application is in the mode and a second appearance that is different from the first appearance, when the application is in the mode. By selecting the control object 306, the user can toggle between the mode and a mode to edit digital multimedia content items.

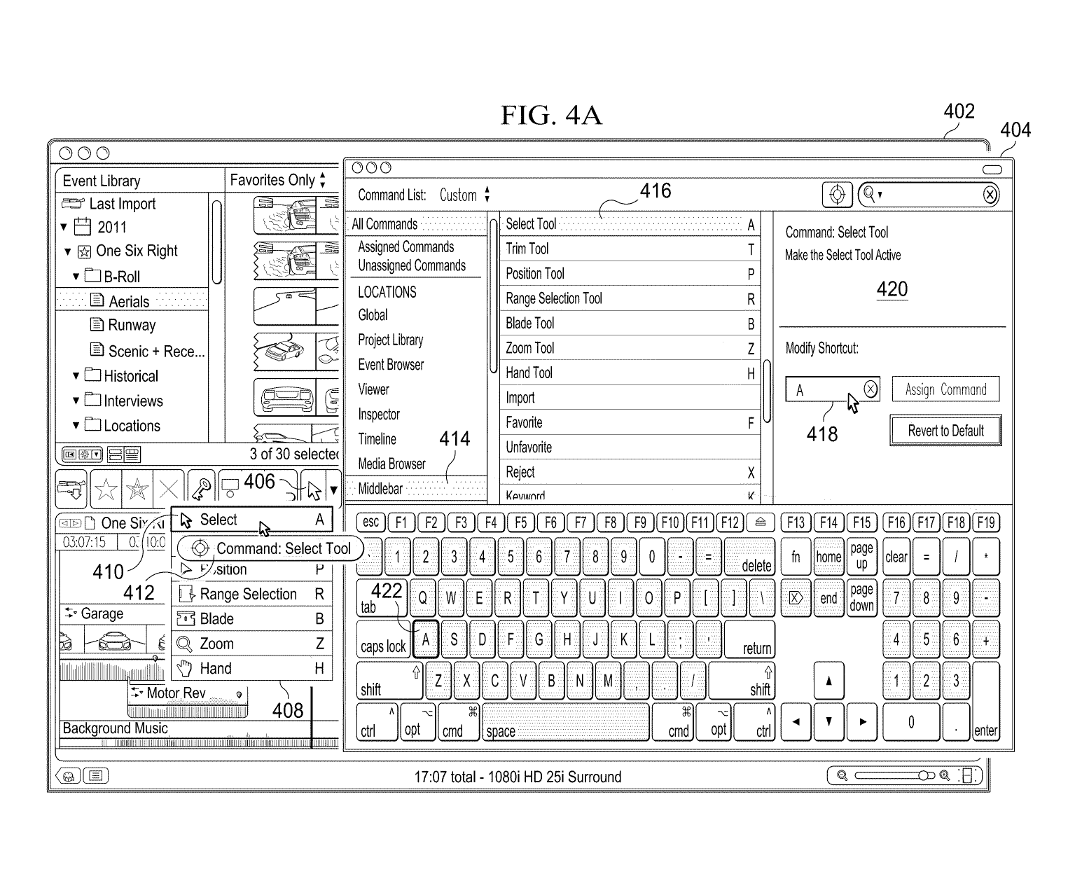

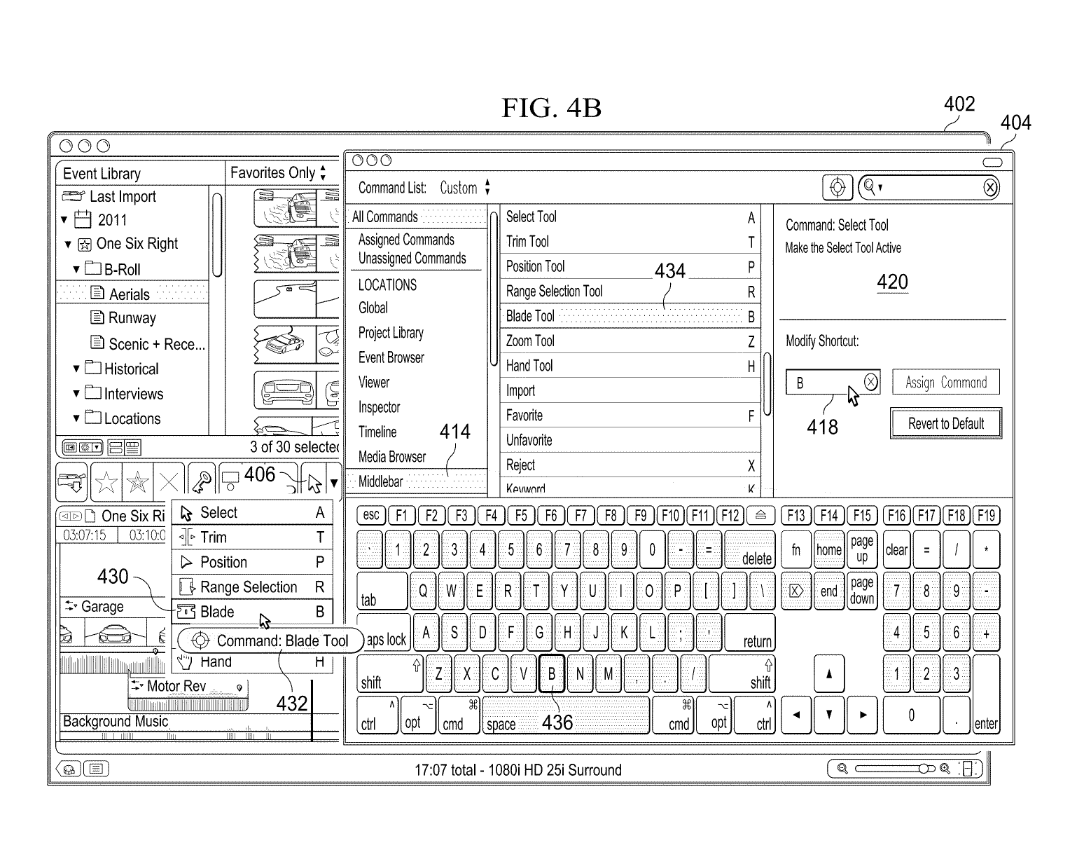

As shown in FIG. 4A, the computer system 100 can display a first user interface 402 upon executing the digital multimedia editing application, as described above. In response to receiving input to place the application in the mode, i.e., to present information describing portions of the user interfaces provided by the application, the computer system 100 can display the second user interface 404 adjacent to (for example, over) the first user interface 402. In a portion of the first user interface 402, the computer system 100 can display a control object 406 that collectively represents multiple control objects, each associated with a respective command. For example, the control object 406 can collectively represent control objects, each of which is associated with a respective command to perform a selection-related operation.

While the computer system 100 executes the application in the mode, the user can select the control object 406 causing the computer system 100 to display a drop-down menu 408 including the multiple control objects. From the drop-down menu 408, the user can select the control object 410 (for example, the “Select” control object). When the user positions the position indicator (for example, cursor arrow) over the control object 410, the computer system 100 can identify a command associated with the control object 410 (in this example, “Command: Select Tool”) and display the command in an object 412 (for example, a tool tip). In this manner, the computer system 100 can enable the user to easily and quickly identify a command associated with a control object displayed in the user interface 402.

When the user selects the control object 410, the computer system 100 can display the control object 410 such that the object can be visually discerned from the rest of the user interface 402 (for example, by placing a highlight around the control object 410). In the second user interface 404, the computer system 100 can display information describing the command associated with the control object 410. For example, the computer system 100 can display, in the second user interface 404, names of the multiple portions included in the user interface 402. In the example second user interface 404, the computer system 100 can display the following names—“Global,” “Project Library,” “Event Browser,” “Viewer,” “Inspector,” “Timeline,” “Media Browser,” “Middlebar,” to name a few.

The computer system 100 can identify the name of the portion of the user interface 402 in which the control object 410 is displayed (“Middlebar,” in this example). The computer system 100 can place a focus on a selectable object 414 in the second user interface 404. In the second user interface 404, the computer system 100 can list names of all commands that can be received through the first user interface 402. For example, the computer system 100 can store multiple names of multiple commands in a computer-readable storage medium (for example, CRM 120). The computer system 100 can access the multiple names from the CRM 120 and display the names in a scrollable list in the second user interface 404. The computer system 100 can identify a name of a command associated with the selectable control object 410 (“Select Tool,” in this example), display the name as the first name in the list (for example, at the top of the list) in the second user interface 404 in a control object 416, and place the focus on the control object 416. In the portion 420 of the second user interface 404, the computer system 100 can display a description of the command associated with the control object 410. In this example, the computer system 100 can display “Make the Select Tool active” in the portion 420. The computer system 100 can additionally determine that a shortcut key (or keys) has been assigned to the command associated with the control object 410, and can display the shortcut key (the key “A,” in this example) in a selectable control object 418 (for example, a textbox).

The computer system 100 can display a virtual keyboard including all alphanumeric keys on a keyboard in the second user interface 404. As described above, the computer system 100 can detect a selection of a alphanumeric key of the multiple alphanumeric keys displayed on the virtual keyboard. The computer system 100 can identify one or more alphanumeric keys, which, in combination with the alphanumeric key, have been assigned as respective one or more respective keyboard shortcut keys to respective one or more commands. The computer system 100 can display respective one or more visual indicators over each of the respective one or more alphanumeric keys. In this example, the computer system 100 can display the visual indicator over the key “A” in the virtual keyboard. The user can modify the shortcut key, for example, by selecting one or more different keys on the virtual keyboard, as described above.

FIG. 4B illustrates another example of a user interface that displays keyboard shortcut keys to provide another command to the application. After selecting the “Select” control object under the control object 406, the user can select the “Blade” control object 430. When the user positions the position indicator over the “Blade” control object 430, the computer system 100 can display the tool tip 432 in which the computer system 100 can display “Command: Blade Tool.” Because the “Blade” control object 430 is also included in the “Middlebar” portion of the first user interface 402, the computer system 100 can retain focus on the object 414 that displays “Middlebar.” The computer system 100 can move focus from the object that displayed “Select Tool” to the object 434 that displays “Blade Tool” and the shortcut key “B” assigned to the command associated with the control object 430. The computer system 100 can display the description of the command associated with the control object 430 in the portion 420 of the second user interface 404, display the shortcut key “B” in the control object 418, and display a highlight over the “B” key 436 in the virtual keyboard.

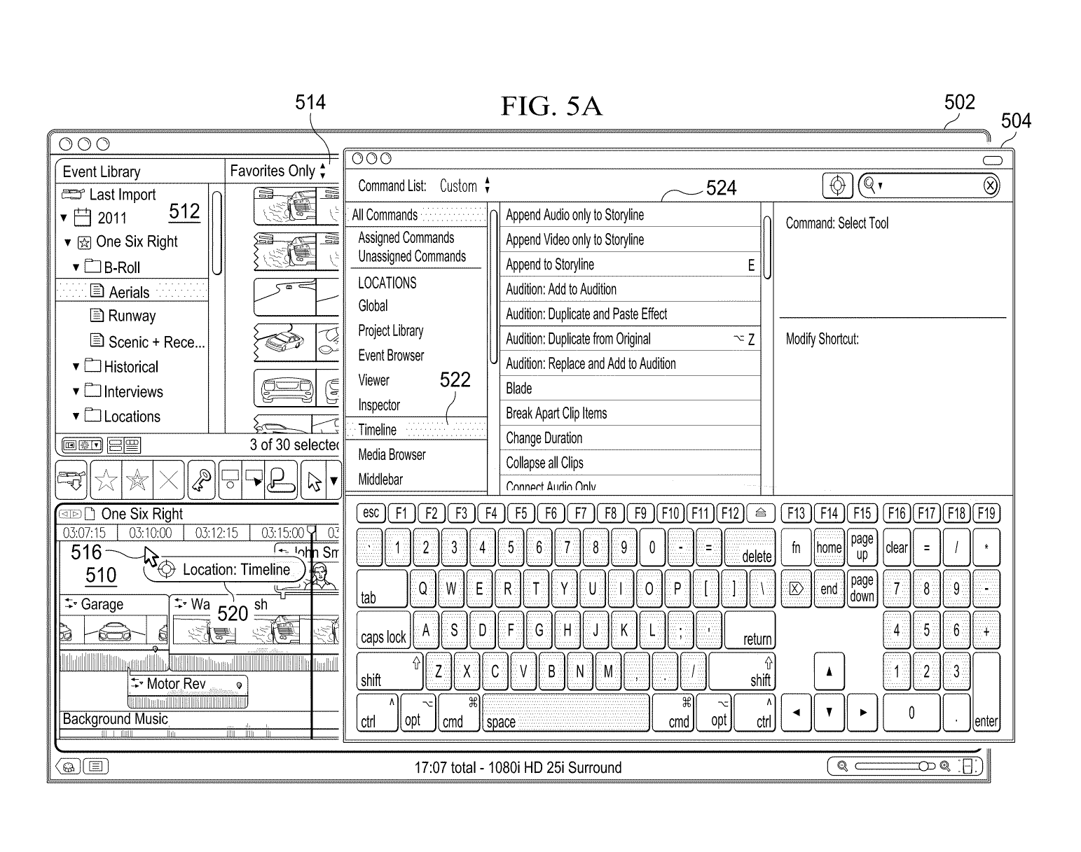

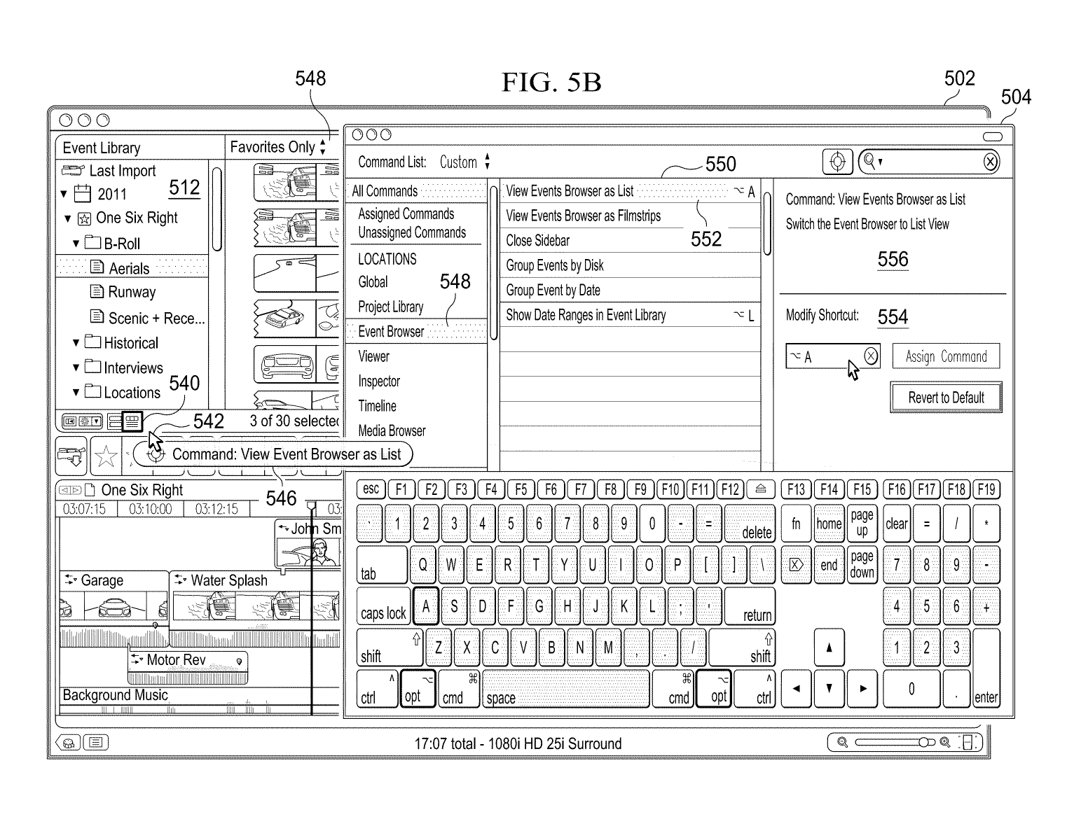

In some implementations, instead of or in addition to selecting a control object (such as control object 410), the user can select a portion of the first user interface. As shown in FIG. 5A, the first user interface 502 can include multiple portions—a first portion 510 (a “Timeline” portion), a second portion 512 (a “Project Library” portion), a third portion 514 (an “Event Browser” portion), to name a few. As described above, each portion can be associated with multiple commands that are logically related to the portion. The computer system 100 can detect input to place the application in the mode to present information describing portions of the user interfaces provided by the application. While executing the application in that mode, the computer system 100 can detect a placement of a position indicator 516 adjacent (for example, over) the first portion 510. In response, the computer system 100 can identify a name of the first portion 510 (“Timeline,” in this example), and display the name in an object 520, for example, a tool tip. The computer system 100 can detect a selection of the first portion 510 using the position indicator 516. The computer system 100 can additionally display a visual indicator in the first portion 510 in response to detecting the placement of the position indicator 516 adjacent the first portion 510. For example, the computer system 100 can display a highlight over the entire first portion 510.

As described above, the first portion 510 can be associated with a subset of the multiple commands. The computer system 100 can display names of the subset of the multiple commands in a second user interface 504, information describing each command, and keyboard shortcut keys assigned to one or more commands in the second user interface 504. In the second user interface 504, the computer system 100 can place focus over an object 522 that displays a name of the first portion 510 (“Timeline,” in this example). In the portion 524 of the second user interface 504, the computer system 100 can display names of commands associated with the first portion 510. As described above, the computer system 100 can detect a selection of a name of the names of the commands, determine that the name is associated with a command to which a keyboard shortcut key has been assigned, and display a visual indicator over the keyboard shortcut key assigned to the command.

FIG. 5B illustrates another example of another second user interface 504 that displays information describing commands associated with a portion of a first user interface 502. As shown in FIG. 5B, the computer system 100 can detect a positioning of a position indicator (for example, cursor 542) adjacent to (for example, over) a control object 540 in a portion of the first user interface 502 named “Event Browser.” In response to detecting the positioning of the cursor 542 over the control object 540, the computer system 100 can identify a command associated with the control object 540 (“View Event Browser as List,” in this example) and display the command in a tool tip 546 connected to the cursor 542.

In addition, the computer system 100 can display the second user interface 504, and in the second user interface 504, display a list of names of multiple portions of the user interface 502, for example, under a “LOCATIONS” heading. The list of names can include a control object 548 that displays “Event Browser.” The computer system 100 can place focus on the control object 548. In addition, the computer system 100 can display names of commands associated with the “Event Browser” portion in the portion 550 of the second user interface 504. A subset of all the commands associated with the “Event Browser” portion may have been assigned keyboard shortcut keys. The computer system 100 can display such keyboard shortcut keys adjacent to the names of the respective commands to which the shortcut keys have been assigned. In some implementations, the computer system 100 can place focus on a control object 552 that displays the name of the command displayed at a top of the list in the portion 550.

As described above, the computer system 100 can display a description of the command on which focus has been placed in the portion 556 of the second user interface 504. In this example, the computer system 100 can display “Switch the event browser to list view” in the portion 552 of the second user interface 504. In the portion 554, the computer system 100 can display the keyboard shortcut key assigned to the command in the control object 552. As described above, the computer system 100 can modify the keyboard shortcut key in response to detecting input to do so in the second user interface 504. In some implementations, in response to detecting the input to modify the keyboard shortcut key, the computer system 100 can determine that a modified keyboard shortcut key has been assigned to perform another command of the application. The computer system 100 can then display a message in the second user interface 504 notifying that the modified keyboard shortcut key has been assigned to perform the other command. As described above, a user can either select a different keyboard shortcut key or overwrite the existing shortcut key.

To assign a shortcut key to a command to which a shortcut key has not been assigned, the user can select a control object in the second user interface 504 that displays the name of the command. Similarly, to modify a shortcut key to command, the user can select a control object in the second user interface 504 that displays the name of the command. To view commands associated with a different portion of the first user interface 502, the user can either select the name of the portion in the second user interface 504 or select the portion in the first user interface 502, or both. In this manner, the computer system 100 can execute the application to enable the user to view commands associated with multiple portions of the user interfaces provided by an application and to assign or modify (or both) keyboard shortcut keys assigned to one or more of the commands.

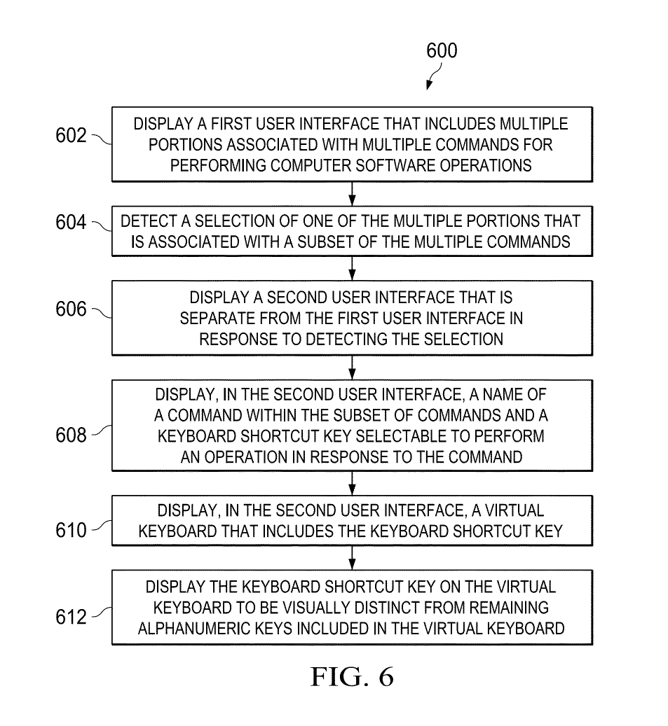

FIG. 6 is a flowchart of a process 600 for displaying names of commands and keyboard shortcut keys assigned to some of the commands in user interfaces. The process 600 can be implemented as computer instructions stored on a computer-readable medium, such as CRM 120, and executable by data processing apparatus, such as DPA 122. For example, the process 600 can be implemented by the computer system 100. At 602, a first user interface associated with a computer software application can be displayed. The first user interface can include multiple portions, each of which is associated with a command to perform a computer software operation of the computer software application in response to the command. At 604, a selection of a portion that is associated with a command can be detected. At 606, a second user interface, that is separate from the first user interface, can be displayed in response to detecting the selection. At 608, a name of the command and a keyboard shortcut key selectable to perform a computer software operation in response to the command, can be displayed. At 610, a virtual keyboard that includes multiple alphanumeric keys including the keyboard shortcut key can be displayed in the second user interface. At 612, the keyboard shortcut key can be displayed on the virtual keyboard to be visually distinct from remaining alphanumeric keys of the multiple alphanumeric keys included in the virtual keyboard.

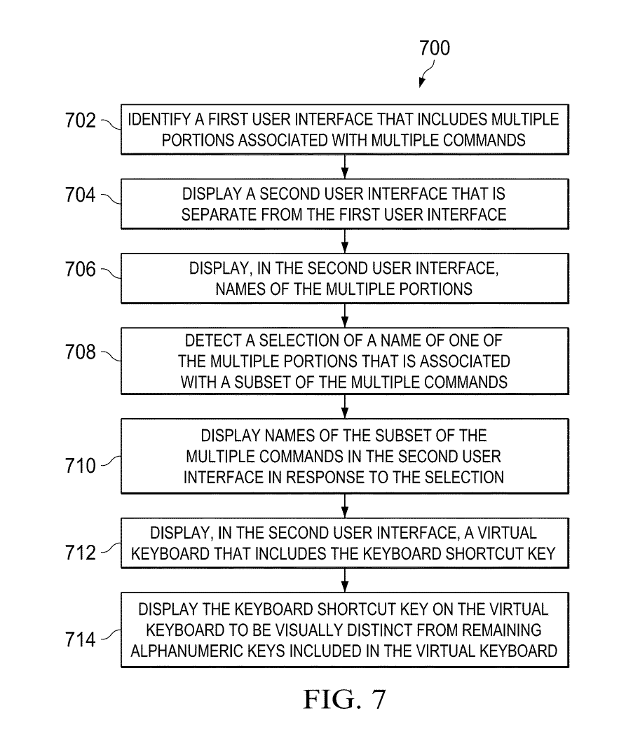

FIG. 7 is a flowchart of a process 700 for displaying names of multiple commands associated with portions of a user interface. The process 700 can be implemented as computer instructions stored on a computer-readable medium, such as CRM 120, and executable by data processing apparatus, such as DPA 122. For example, the process 700 can be implemented by the computer system 100. At 702, a first user interface associated with a computer software application can be identified. The first user interface can include multiple portions, each of which is associated with respective multiple commands to perform respective multiple computer software operations of the computer software application. At 704, a second user interface, that is separate from the first user interface, can be displayed. At 706, names of the multiple portions can be displayed in the second user interface. A keyboard shortcut key has been assigned to a command of the multiple commands. At 708, a selection of a name of a portion that is associated with multiple commands can be detected. At 710, names of the multiple commands can be displayed in the second user interface in response to detecting the selection of the name of the portion. At 712, a virtual keyboard that includes multiple alphanumeric keys including the keyboard shortcut key can be displayed in the second user interface. At 714, the keyboard shortcut key on the virtual keyboard can be displayed to be visually distinct from remaining alphanumeric keys of the multiple alphanumeric keys included in the virtual keyboard.

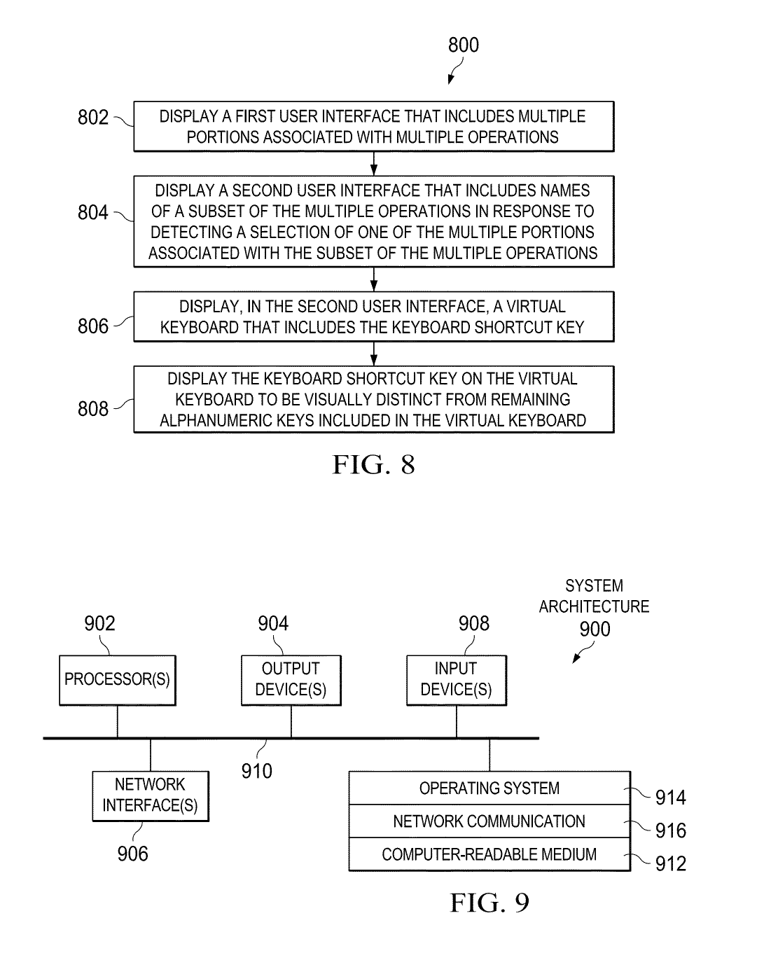

FIG. 8 is a flowchart of a process for displaying names of multiple commands associated with portions of a user interface. The process 800 can be implemented as computer instructions stored on a computer-readable medium, such as CRM 120, and executable by data processing apparatus, such as DPA 122. For example, the process 800 can be implemented by the computer system 100. At 802, a first user interface that includes multiple portions can be displayed. Each of the multiple portions can be associated with respective multiple computer software operations of a computer software application. At 804, a second user interface that includes names of multiple computer software operations can be displayed in response to detecting a selection of a portion associated with the multiple computer software operations. A keyboard shortcut key has been assigned to a computer software operation of the multiple computer software operations. At 806, a virtual keyboard can be displayed in the second user interface. The virtual keyboard can include multiple alphanumeric keys including the keyboard shortcut key. At 808, the keyboard shortcut key on the virtual keyboard can be displayed to be visually distinct from remaining keys of the multiple alphanumeric keys included in the virtual keyboard.

FIG. 9 is a block diagram of an exemplary architecture for implementing the features and operations of FIGS. 1-8. Other architectures are possible, including architectures with more or fewer components. In some implementations, architecture 900 includes one or more processors 902 (e.g., dual-core Intel® Xeon® Processors), one or more output devices 904 (e.g., LCD), one or more network interfaces 906, one or more input devices 908 (e.g., mouse, keyboard, touch-sensitive display, microphone to receive audio input) and one or more computer-readable mediums 912 (e.g., RAM, ROM, SDRAM, hard disk, optical disk, flash memory, etc.). These components can exchange communications and data over one or more communication channels 910 (e.g., buses), which can utilize various hardware and software for facilitating the transfer of data and control signals between components.

The term “computer-readable medium” refers to a medium that participates in providing instructions to processor 902 for execution, including without limitation, non-volatile media (e.g., optical or magnetic disks), volatile media (e.g., memory) and transmission media. Transmission media includes, without limitation, coaxial cables, copper wire and fiber optics.

Computer-readable medium 912 can further include operating system 914 (e.g., a Linux® operating system) and network communication module 916. Operating system 914 can be one or more of multi-user, multiprocessing, multitasking, multithreading, real time, etc., or combinations of them. Operating system 914 performs basic tasks, including but not limited to: recognizing input from and providing output to devices 904, 908; keeping channel and managing files and directories on computer-readable mediums 912 (e.g., memory or a storage device); controlling peripheral devices; and managing traffic on the one or more communication channels 910. Network communications module 916 includes various components for establishing and maintaining network connections (e.g., software for implementing communication protocols, such as TCP/IP, HTTP, etc.).

Architecture 900 can be implemented in a parallel processing or peer-to-peer infrastructure or on a single device with one or more processors. Software can include multiple software components or can be a single body of code.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, a browser-based web application, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks, magneto-optical disks, and optical disks. Storage devices suitable for tangibly embodying computer program instructions and data include all forms of non-volatile memory, including by way of example, semiconductor memory devices, such as EPROM, EEPROM, and flash memory devices, magnetic disks such as internal hard disks and removable disks, magneto-optical disks, and CD-ROM and DVD-ROM disks. The processor and the memory can be supplemented by, or incorporated in, ASICs (application-specific integrated circuits).

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular actions by virtue of having software, firmware, hardware, or a combination of them, installed on the system that in operation causes or cause the system to perform the actions. One or more computer programs can be configured to perform particular actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations of the invention have been described. Nevertheless, it will be understood that various modifications can be made without departing from the spirit and scope of the invention.

What is claimed is:

1. A computer-implemented method comprising:
displaying a first user interface associated with a computer software application, wherein the first user interface includes a plurality of portions associated with a plurality of commands for performing computer software operations of the computer software application;
detecting a selection of one of the plurality of portions that is associated with a subset of the plurality of commands;
displaying a second user interface that is separate from the first user interface in response to detecting the selection;
displaying, in the second user interface, a name of a command within the subset of commands and a keyboard shortcut key selectable to perform a computer software operation in response to the command;
displaying, in the second user interface, a virtual keyboard that includes a plurality of alphanumeric keys including the keyboard shortcut key; and
displaying the keyboard shortcut key on the virtual keyboard to be visually distinct from remaining alphanumeric keys of the plurality of alphanumeric keys included in the virtual keyboard.

2. The method of claim 1, wherein detecting the selection comprises:
detecting a placement of a position indicator adjacent the one of the plurality of portions; and
detecting a selection of the one of the plurality of portions using the position indicator.

3. The method of claim 2, further comprising displaying a name of the one of the plurality of portions in response to detecting the placement of the position indicator adjacent the one of the plurality of portions.

4. The method of claim 3, further comprising displaying a visual indicator in the one of the plurality of portions in response to detecting the placement of the position indicator adjacent the one of the plurality of portions.

5. The method of claim 1, further comprising:
displaying, in the second user interface, names of the plurality of portions including a name of the one of the plurality of portions; and
placing a focus on the name of the one of the plurality of portions in the second user interface.

6. The method of claim 1, wherein the one of the plurality of portions includes a control object selectable to perform the command.

7. The method of claim 1, further comprising:
detecting input to place the computer software application in a mode; and
displaying the second user interface in response to detecting the selection when the computer software application is in the mode.

8. The method of claim 1, further comprising modifying the keyboard shortcut key in response to detecting input to modify the keyboard shortcut key in the second user interface.

9. The method of claim 8, further comprising, in response to detecting the input to modify the keyboard shortcut key:
determining that a modified keyboard shortcut key has been assigned to perform another command of the computer software application; and
displaying a message in the second user interface notifying that the modified keyboard shortcut key has been assigned to perform the other command.

10. The method of claim 1, further comprising:
storing a plurality of names of a plurality of commands in a computer-readable storage medium, wherein the plurality of names include the name of the command, and wherein the plurality of names can be displayed in a list; and
wherein displaying, in the second user interface, the name of the command comprises:
identifying the name from the plurality of names; and
displaying the identified name as a first name in the list.

11. A non-transitory computer-readable medium storing instructions executable by data processing apparatus to perform operations comprising:
identifying a first user interface associated with a computer software application, wherein the first user interface includes a plurality of portions associated with a plurality of commands for performing computer software operations of the computer software application;
displaying a second user interface that is separate from the first user interface;
displaying, in the second user interface, names of the plurality of portions; and
detecting a selection of a name of one of the plurality of portions that is associated with a subset of the plurality of commands;
displaying names of the subset of the plurality of commands in the second user interface in response to detecting the selection of the name of the one of the plurality of portions, wherein a keyboard shortcut key has been assigned to a command of the subset of the plurality of commands;
displaying, in the second user interface, a virtual keyboard that includes a plurality of alphanumeric keys including the keyboard shortcut key; and
displaying the keyboard shortcut key on the virtual keyboard to be visually distinct from remaining alphanumeric keys of the plurality of alphanumeric keys included in the virtual keyboard.

12. The medium of claim 11, wherein the operations further comprise:
displaying, in the second user interface, a selectable control; and
displaying, in the second user interface, names of all commands to perform all operations of the computer software application in response to detecting a selection of the selectable control.

13. The medium of claim 12, wherein keyboard shortcut keys have been assigned to a subset of all commands, and wherein the operations further comprise:
displaying, in the second user interface, another selectable control; and
displaying, in the second user interface, names of the subset of all commands to which keyboard shortcut keys have been assigned.

14. The medium of claim 13, wherein the operations further comprise displaying, in the second user interface, keyboard shortcut keys assigned to the subset of all commands.

15. The medium of claim 11, wherein the operations further comprise displaying a visual indicator over each alphanumeric key that has been assigned as a keyboard shortcut key to a command.

16. The medium of claim 15, wherein the operations further comprise:
detecting a selection of a alphanumeric key of the plurality of alphanumeric keys;
identifying one or more alphanumeric keys, which, in combination with the alphanumeric key, have been assigned as respective one or more respective keyboard shortcut keys to respective one or more commands; and
displaying a respective one or more visual indicators over each of the respective one or more alphanumeric keys.

17. The medium of claim 15, wherein the operations further comprise:
detecting a selection of a name of the names of the subset of the plurality of commands;
determining that the name is associated with a command to which a keyboard shortcut key has been assigned; and
displaying a visual indicator over the keyboard shortcut key assigned to the command.

18. The medium of claim 11, wherein the operations further comprise:
detecting a selection of a name of the names of the subset of the plurality of commands;
determining that the name is associated with a command to which a keyboard shortcut key has been assigned; and
displaying, in the second user interface, the keyboard shortcut key assigned to the command.

19. The medium of claim 18, wherein the operations further comprise modifying the keyboard shortcut key in response to detecting input to modify the keyboard shortcut key in the second user interface.

20. A system comprising:
one or more data processing apparatus; and
a computer-readable medium storing instructions executable by the one or more data processing apparatus to perform operations comprising:
displaying a first user interface that includes a plurality of portions associated with a plurality of computer software operations of a computer software application;
displaying a second user interface that includes names of a subset of the plurality of computer software operations in response to detecting a selection of one of the plurality of portions associated with the subset of the plurality of computer software operations, wherein a keyboard shortcut key has been assigned to a computer software operation of the subset of the plurality of computer software operations;
displaying a virtual keyboard in the second user interface, the virtual keyboard including a plurality of alphanumeric keys including the keyboard shortcut key; and
displaying the keyboard shortcut key on the virtual keyboard to be visually distinct from remaining keys of the plurality of alphanumeric keys included in the virtual keyboard.

21. The system of claim 20, wherein the operations further comprise:
displaying a plurality of names assigned to the plurality of portions in the second user interface; and
displaying, in the second user interface, the names of the subset of the plurality of computer software operations in response to detecting a selection of a name assigned to the subset of the plurality of computer software operations.

22. The system of claim 21, wherein the operations further comprise displaying, in the second user interface, keyboard shortcut keys assigned to the subset of the plurality of computer software operations, wherein a keyboard shortcut key is selectable to perform a respective computer software operation.

23. The system of claim 22, wherein the operations further comprise modifying a keyboard shortcut key assigned to a computer software operation in response to detecting input to modify the keyboard shortcut key.

24. The system of claim 23, wherein the operations further comprise:
displaying a keyboard including alphanumeric keys in the second user interface, wherein the alphanumeric keys include keys assigned as keyboard shortcut keys to the computer software applications; and
displaying a visual indicator over the keyboard shortcut keys assigned to the subset of the plurality of computer software operations.
